(19) United States
(12) Patent Application Publication
(10) Pub. No.: US 2012/0189770 A1
(43) Pub. Date: Jul. 26, 2012

(54) PREPARING LITHOGRAPHIC PRINTING PLATES BY ABLATION IMAGING

(76) Inventors: Moshe Nakash, Ramat Hashron (IL); Ophira Melamed, Shoham (IL); Eynat Matzner, Adi (IL); Anna Sigalov, Natanya (IL)

(21) Appl. No.: 13/009,985

(22) Filed: Jan. 20, 2011

(51) Int. Cl. B41M 1/06; B29C 35/08

(52) U.S. Cl. 427/144; 264/400

(57) ABSTRACT

Lithographic printing plates can be prepared and made ready for lithographic printing without wet development or processing. A positive-working lithographic printing plate precursor is exposed to ablating infrared radiation of an energy of at least 1 J/cm² to form a lithographic printing plate ready for lithographic printing. The positive-working lithographic printing plate precursor has a hydrophilic aluminum substrate, and on the substrate, a crosslinked hydrophilic inner layer, and an oleophilic surface layer that is chemically bonded to the crosslinked hydrophilic inner layer. An intermediate layer provided between the crosslinked hydrophilic inner and oleophilic surface layers. Either this intermediate or the oleophilic surface layer, or both, generally includes an infrared radiation absorbing compound.

### FIELD OF THE INVENTION

This invention relates to a method for preparing lithographic printing plates from precursors having at least two adhered layers one of which is an oleophilic surface layer that is imageable by ablation using high powered lasers. Such imaged lithographic printing plates can be used for printing without wet processing steps.

### BACKGROUND OF THE INVENTION

Offset lithographic printing has remained important in many areas of printing for several reasons. For continual printing methods, offset lithography has provided simplicity, cost-effectiveness, and high print quality.

Modern technology permits the generation of all kinds of digital data including images, text, and collections and arrangements of data in personal computers or other storage devices in a way that is useful in the generation of printed copy. The data are then directed to a CTP (Computer-to-Plate) device where it is used to modulate a laser (or array of lasers) that “writes” the digital data onto lithographic printing plate precursors. The resulting latent images in the precursors generally require wet processing in a developer to differentiate the regions that will accept ink from the background regions that reject ink during the printing process.

The concept of using laser energy to digitally image printing plates has closely followed the development of lasers. Early lasers were powerful but slow and expensive. U.S. Pat. No. 3,574,657 (Burnett) describes the use of a thermally crosslinked resin on a hydrophilic aluminum substrate that is imaged by thermal laser removal of the resin. Early imaging using lasers was slower than existing chemical etching techniques. The laser power required at a given spot was quite high and the heat generated was also high. The material had to be completely vaporized for an interval sufficient to ensure its removal. Consequently, there was a great quantity of thermal energy transferred to the surrounding area that had to be removed before another spot could be etched. Clearly, the art had not progressed to the level where the thermal energy could be removed quickly enough to enable laser etching to compete in speed with chemical etching. In addition to slow production, the printing plates produced images that were unacceptably irregular and lacking in definition. A suitable exposure system would use argon ion, helium-cadmium, and other lasers of like nature to image commercially available diazo-sensitized layers on aluminum supports. The imaged printing plates were processed using a developer.

U.S. Pat. No. 4,020,762 (Peterson) describes the use of a YAG laser to remove non-image areas, and the imaged areas were then exposed to UV light and developed using an additive developer.

U.S. Pat. No. 4,054,094 (Caddell et al.) describes the imaging of a lithographic printing plate precursor that has an aluminum base coated with a hydrophilic coating using a laser to burn away the coating and causing the aluminum surface to become oleophilic in the imaged areas leaving hydrophilic areas of the substrate. Such laser “burning” has become known as laser ablation.

An additional approach to simplification of the offset lithographic printing process is described in U.S. Pat. No. 3,511,178 (Curtin) in which the concept of waterless printing was introduced by using printing plate precursors coated with polydimethyl siloxane (silicone) that preferentially rejected ink during printing and formed the areas corresponding to the background. GB Patent Publication 1,489,308 (Eames) combined the ideas of waterless printing and laser ablation.

U.S. Pat. No. 4,693,958 (Schwartz et al.) describes use of a specific range of hydrophilic polymers curable to hydrophobic material using an infrared laser and then washing off the uncured non-imaged background regions using water or a neutral or alkaline solution.

Although the concepts described in this art were useful, in practice they created a number of problems that were not evident until later. They are expensive, slow, and require high power as described in U.S. Pat. No. 5,339,737 (Lewis et al.). U.S. Pat. No. 5,605,780 (Burberry et al.) describes the use of a poly(cyanoacrylate) imaging layer on hydrophilic aluminum that is ablatable using an array of lower-powered lasers.

A significant advantage of using laser ablation for imaging is that as the ablated material is destroyed there is minimal development needed after imaging. Development can be carried out using a wet processing solution or wet development can be omitted. Conventional lithographic printing plate making generally requires formulated processing solutions for development to wash away material in the background regions of the imaged printing plate. These processing solutions can be unstable and during use they become contaminated with the removed material so that they require replenishment or regeneration on a periodic basis.

Ideally, imaging by ablation should require no such processing solutions but in practice this is not the case. For instance, in U.S. Pat. No. 5,339,737 (noted above), ablated material can be cleaned using only a rotating brush. If the ablated printing plate could be used without the need for a cleaning process, the making of printing plates would be significantly simplified because even the simplest water washing step and processor unit could be eliminated. Even a drying step could be avoided. U.S. Pat. No. 5,962,188 (DeBoer et al.) describes an attempt to eliminate cleaning entirely by using a hydrophilic topcoat in the imaged precursor. However, the printing run lengths shown in this reference suggest that an improvement is needed. EP 1,957,273 (Aert) describes imaging in a switchable surface coating (for example, hydrophilic to oleophilic or vice-versa) but a wet gumming step is still required.

Other researchers in recent years sought to produce conventional wet offset lithographic printing plate precursors that are imaged by laser ablation but the imaged precursors still require treatment to remove debris. Lithographic printing plate formulations have been specifically designed to allow for cleaning with the simplest of solutions, such as water (for example, U.S. Pat. No. 5,493,971 of Lewis et al. describes a two-layer plate construction with a protective layer over the grained metal substrate to protect the substrate during ablation). U.S. Pat. Nos. 4,581,258 and 4,522,912 (both Sharkovsky) describe the use of zirconium ammonium carbonate as a glass-like film between the metal substrate and a photopolymer layer. U.S. Pat. No. 4,063,949 (Uhlig et al.) describes the use of water-insoluble hydrophilic layers between the metal substrate and light sensitive layers. Other protective layers can comprise hydrophilic layers in the form of crosslinked polymers.

U.S. Pat. Nos. 6,182,569, 6,182,570, and 6,192,798 (all Rorke et al.) describe the problems of formulations designed to accommodate post-imaging development. For example, there can be a loss of adhesion of the protective hydrophilic thermal barrier layer because too much solvent or solubilizing action by the processing solution can erode the protective layer, degrading small image areas. Rorke et al. attempted to formulate protective layers that would not be harmed by processing solutions. They describe a combination of an oleophilic upper layer that is characterized by the absence of ablative absorption coated over an oleophilic second layer that contains the IR sensitizer, which in turn is coated onto a hydrophilic layer coated on a hydrophilic substrate. For example, Rorke et al. describe a poly(vinyl alcohol) that has been crosslinked using zirconium ammonium carbonate to provide a water resistant hydrophilic layer.

Crosslinked poly(vinyl alcohol) is described in U.S. Pat. No. 4,063,949 (Uhlig) and the use of zirconium ammonium carbonate as a crosslinking agent for poly(vinyl alcohol) is also described in U.S. Pat. Nos. 5,268,030 and 6,182,570 (both Floyd et al.). The use of hydrophilic insulating layers over metal surfaces such as aluminum substrates are also known as described for example in GB 1,289,308 (Scott Paper).

Another important consideration in the construction of laser imageable lithographic printing plate precursors is the sensitivity of the coatings to laser imaging radiation. Non-ablation imageable precursors that require wet development can have sensitivities as low as 30 mJ/cm² (see for instance U.S. Pat. No. 7,399,576 of Levanon), whereas ablation-imageable lithographic printing plates have lower sensitivities and can typically be imaged at 400-700 mJ/cm² (see, for instance U.S. Pat. No. 6,357,352 of Rorke et al.).

It has generally been desired to make lithographic printing plate precursors as sensitive as possible to make imaging as fast as possible and to use a minimum of laser diodes to keep down costs. Therefore, the focus in the industry has been to formulate imageable compositions that have high sensitivity. There is little focus on making lithographic printing plate precursors with low sensitivity.

The correct exposure level for a lithographic printing plate precursor is also important. For positive-working ablatable lithographic printing plate precursors, if the energy level used is too low, the background will not be adequately removed and scumming will be evident during printing. If too much energy is used, fine details will not be seen in printed images. Thus a lithographic printing plate precursor must always be formulated to be within the imaging capability of the imaging machine at hand. In general, imaging machines have the flexibility to be used with lithographic printing plate precursors of various sensitivities by altering energy or imaging speed. If the precursor has very low sensitivity, it is possible that the imaging machine will not have sufficient power for imaging and if the precursor has too high a sensitivity, the imaging machine cannot be sufficiently sped up or the imaging energy sufficiently lowered to give correct exposure.

There is a need to avoid the problems described above. Specifically, it is desired to avoid wet processing solutions and development steps, and thereby avoid the need to specifically design lithographic printing plate precursors for specific processing solutions.

### SUMMARY OF THE INVENTION

This invention provides a method of preparing a lithographic printing plate ready for lithographic printing comprising:

exposing a positive-working lithographic printing plate precursor to ablating infrared radiation of an energy of at least 1 J/cm² to form an ablated image in a lithographic printing plate ready for lithographic printing, wherein the positive-working lithographic printing plate precursor comprises a hydrophilic aluminum substrate, and comprises on the substrate:

a crosslinked hydrophilic inner layer, and

an oleophilic surface layer that is chemically bonded to the crosslinked hydrophilic inner layer, the oleophilic surface layer comprising at least one non-crosslinked oleophilic polymer.

This method can further comprise:

without intermediate contact with a solution, using the lithographic printing plate having the ablated image for lithographic printing.

In addition, this invention provides a method for preparing a lithographic printing plate precursor comprising:

to a hydrophilic aluminum substrate, applying an inner layer formulation comprising a hydrophilic polymer and a crosslinking agent for the hydrophilic polymer and drying to form a crosslinked hydrophilic inner layer,

applying an oleophilic surface layer formulation comprising at least one non-crosslinked oleophilic polymer to form an oleophilic surface layer on the hydrophilic inner layer,

drying the applied oleophilic surface layer to affect chemical bonding of the oleophilic surface layer to the crosslinked hydrophilic inner layer.

The present invention utilizes commercially available, relatively high-powered infrared laser diodes for ablative imaging. In order to do this, we formulated lithographic printing plate precursors having low sensitivities so that high imaging energy can be used. This approach is somewhat counterintuitive because of the inclination of those skilled in the art to seek imageable formulations having higher sensitivity. However, ablative imaging at higher energy is believed to result in smaller molecules of decomposed materials that are carried away as volatiles and that can be trapped in an imaging machine filtration system. This invention thus eliminates the need for a separate cleaning step after imaging.

We found that positive-working lithographic printing plate precursors can best be formulated using a standard anodized, grained aluminum substrate that has a crosslinked hydrophilic coating on it, and applying an oleophilic surface layer having an imaging sensitivity of at least 1 J/cm². During the last drying step, the oleophilic surface layer is chemically bound to the underlying inner layer at the interface, or both layers are chemically bound to an intermediate layer at the two interfaces. However, the internal portion of the oleophilic surface layer is generally non-crosslinked. The interface of the oleophilic surface layer can be crosslinked as it is chemically bound to the underlying layer, whether it is the intermediate layer or the crosslinked hydrophilic inner layer.

The ablatable oleophilic surface layer desirably has high solvent resistance but is generally non-crosslinked. To achieve these results, we use a class of polymers in the oleophilic surface layer that can be formed from a solvent but in which the layer is no longer soluble after drying. Such polymers are selected from a specific class of poly(vinyl acetal)s that are generally described for use in laser imageable, non-ablatable offset lithographic printing plate precursors. Some of these polymers are described for example, in WO04/081662 (Memetea et al.) and U.S. Pat. Nos. 6,255,033 and 6,541,181 (both Levanon et al.). The imaged lithographic printing plate precursors described in these publications are developed using various aqueous processing solutions. For reasons noted above, there is a need to avoid the use of aqueous processing solutions, and we have found that such wet processing unnecessary with the practice of this invention.

By using an oleophilic surface layer that is generally non-crosslinked, the lithographic printing plate precursors used in this invention have sufficient sensitivity because the high energy imaging laser is not required to break so many chemical bonds during imaging, but the layer has sufficient solvent resistance to the solvents encountered during lithographic printing.

Effective adhesion between the oleophilic surface layer and the underlying layer in the lithographic printing plate precursors used in this invention has been provided by the use of a crosslinking agent that is effective for adhering the crosslinked hydrophilic inner layer (or intermediate layer) at the interface with the oleophilic surface layer. A crosslinking agent can be incorporated into the hydrophilic inner layer or the intermediate layer, or both of these layers. More details of the crosslinking agents are provided below. The optional intermediate layer (described below) can contain an infrared radiation absorbing compound and can be either hydrophilic or oleophilic. If the intermediate layer is oleophilic, during the imaging ablation, it should be sufficiently ablated away so as to leave the exposed surface totally hydrophilic. If the intermediate layer is hydrophilic, it need not be totally ablated.

We have found that the present invention provides a way for imaging and printing without contact with any solution, using imaging energies of at least 1.0 J/cm². Thus, the present invention and its advantages can be achieved using currently available higher-powered laser diodes.

Further details of the advantages of the present invention will become apparent in consideration of the disclosure provided below.

### DETAILED DESCRIPTION OF THE INVENTION

### Definitions

Unless the context otherwise indicates, when used herein, the terms “positive-working lithographic printing plate precursor” and “lithographic printing plate precursor” are meant to be references to embodiments used or prepared in the practice of the present invention.

In addition, unless the context indicates otherwise, the various components described herein such as “non-crosslinked oleophilic polymer” “crosslinked polymeric binder”, “infrared radiation absorbing compound”, and “crosslinking agent” also refer to mixtures of each component. Thus, the use of the articles “a”, “an”, and “the” is not necessarily meant to refer to only a single compound.

Unless otherwise indicated, percentages refer to percents by weight. Percent by weight can be based on the total solids in a formulation or composition, or on the total dry coating weight of a layer.

As used herein, the term “infrared radiation absorbing compound” refers to compounds that are sensitive to at least one wavelength of near infrared and infrared radiation and can convert photons into heat within the layer in which they are disposed. These compounds can also be known in the art as “photothermal conversion materials”, “sensitizers”, or “light to heat convertors”.

For clarification of definition of any terms relating to polymers, reference should be made to “Glossary of Basic Terms in Polymer Science” as published by the International Union of Pure and Applied Chemistry (“IUPAC”), Pure Appl. Chem. 68, 2287-2311 (1996). However, any different definitions set forth herein should be regarded as controlling.

The term “polymer” refers to high and low molecular weight polymers including oligomers and can include both homopolymers and copolymers.

The term “copolymer” refers to polymers that are derived from two or more different monomers, or have two or more different types of recurring units, even if derived from the same monomer. Unless otherwise noted, the different constitutional recurring units are present in random order along the copolymer backbone.

The term “backbone” refers to the chain of atoms in a polymer to which a plurality of pendant groups are attached. An example of such a backbone is an “all carbon” backbone obtained from the polymerization of one or more ethylenically unsaturated polymerizable monomers. However, other backbones can include heteroatoms wherein the polymer is formed by a condensation reaction of some other means.

### Lithographic Printing Plate Precursors

The lithographic printing plate precursors are positive-working imageable elements so that imaged (exposed) regions in the oleophilic surface layer are substantially removed during imaging and the non-imaged (non-exposed) regions of that layer remain in the imaging surface of the resulting lithographic printing plate. Any debris can be removed by dry cleaning or in the fountain solution during printing.

Substrates:

In their simplest form, the lithographic printing plate precursors are formed by suitable application of a hydrophilic inner layer formulation onto the substrate, which formulation is dried, and an oleophilic surface layer formulation is applied onto the hydrophilic inner layer. This oleophilic surface layer formulation can also be generally considered to have the capability of absorbing infrared radiation, for example containing an infrared radiation absorbing compound as described below. More details of these manufacturing steps are provided below along with description of the optional intermediate layer that can be disposed between the two other layers.

The substrate is usually treated or coated in various ways as described below prior to application of the hydrophilic inner layer formulation. For example, the substrate can be treated to provide a subbing layer for improved adhesion or hydrophilicity, and the hydrophilic inner layer formulation can be applied over this subbing layer.

The substrate generally has a hydrophilic surface, or a surface that is more hydrophilic than the applied imaging formulation on the imaging side. The substrate comprises a support that can be composed of any material that is conventionally used to prepare imageable elements such as lithographic printing plates. It is usually in the form of a sheet, film, or foil, and is strong, stable, and flexible and resistant to dimensional change under conditions of use so that color records will register a full-color image. Typically, the support can be any self-supporting material including polymeric films (such as polyester, polyethylene, polycarbonate, cellulose ester polymer, and polystyrene films), glass, ceramics, metal sheets or foils, or stiff papers (including resin-coated and metallized papers), or a lamination of any of these materials (such as a lamination of an aluminum foil onto a polyester film). Metal-containing supports include sheets or foils of aluminum, copper, zinc, titanium, and alloys thereof.

Polymeric film supports can be modified on one or both surfaces with a “subbing” layer to enhance hydrophilicity, or paper supports can be similarly coated to enhance planarity. Examples of subbing layer materials include but are not limited to, alkoxysilanes, amino-propyltriethoxysilanes, glycidioxypropyl-triethoxysilanes, and epoxy functional polymers, as well as conventional hydrophilic subbing materials used in silver halide photographic films (such as gelatin and other naturally occurring and synthetic hydrophilic colloids and vinyl polymers including vinylidene chloride copolymers).

Useful substrates are aluminum-containing supports that can be coated or treated using techniques known in the art, including physical graining, electrochemical graining and chemical graining, followed by anodizing. The aluminum sheets are mechanically or electrochemically grained and anodized using phosphoric acid or sulfuric acid and conventional procedures.

An optional interlayer can be formed on the support by treating it with, for example, a silicate, dextrin, calcium zirconium fluoride, hexafluorosilicic acid, phosphate/sodium fluoride, poly(vinyl phosphonic acid) (PVPA), vinyl phosphonic acid copolymer, poly(acrylic acid), or acrylic acid copolymer solution, or an alkali salt of a condensed aryl sulfonic acid as described in GB 2,098,627 and Japanese Kokai 57-195697A (both Hefting et al.). The grained and anodized aluminum support can be treated with poly(acrylic acid) using known procedures to improve surface hydrophilicity.

The thickness of the substrate can be varied but it should be sufficient to sustain the wear from printing and thin enough to wrap around a printing form.

The backside (non-imaging side) of the substrate can be coated with antistatic agents or slipping layer or matte layer to improve handling and “feel” of the imageable element.

The substrate can also be a cylindrical surface having the layers applied thereon, and thus be an integral part of the printing press. The use of such imaged cylinders is described for example in U.S. Pat. No. 5,713,287 (Gelbart).

Crosslinked Hydrophilic Inner Layer:

The first essential layer in the lithographic printing plate precursor is a crosslinked hydrophilic inner layer comprising one or more crosslinked hydrophilic materials, generally crosslinked hydrophilic polymeric binders. For example, such crosslinked hydrophilic polymeric binders can include but are not limited to, crosslinked poly(vinyl alcohol) having a hydrolysis value greater than 98%, crosslinked cellulosic resins, and crosslinked polyacrylic acids. Mixtures of these crosslinked polymeric binders can be used if desired. Such polymeric binders generally comprise at least 50 and up to and including 100 weight % based on the total crosslinked hydrophilic inner layer dry weight. The crosslinked hydrophilic inner layer dry coverage is generally at least 0.5 and up to and including 4 g/m².

The crosslinked hydrophilic polymeric binder is generally obtained using any suitable crosslinking agent, including but not limited to, the compounds that are selected from the group consisting of zirconium ammonium carbonate, tetraethyl orthosilicate, tetramethyl orthosilicate, terephthalic aldehyde, ethane-1,2-dione (and other dialdehydes), and a melamine such as hexamethoxymethyl-melamine that is available as Cymel® 303 crosslinking agent (Cytec Industries). Mixtures of the crosslinking agents can be used. A skilled worker would understand how much crosslinking agent to use based on the amount of hydrophilic polymeric binder to be crosslinked in the formulation. In general, one or more crosslinking agents are provided in the hydrophilic inner layer formulation in an amount of at least 2 and up to and including 50% based on total solids in the formulation. Crosslinking of the polymeric binder generally occurs during the drying stage after the formulation is applied to the substrate, but additional crosslinking can occur during later steps, for example during the drying of successive layer formulations.

Sufficient crosslinking agent is generally present to also provide crosslinking at the interface of the crosslinked hydrophilic inner layer and the immediately overlying layer, that is, either the intermediate layer or the oleophilic surface layer (both described below). For this purpose, a small amount of a crosslinking agent can be present in the oleophilic surface layer, but in most embodiments, there is no crosslinking agent purposely added to the oleophilic surface layer formulation.

This crosslinked hydrophilic inner layer can also include other addenda that would be useful for coating properties, adhesion to the underlying substrate, or adhesion to the overlying intermediate layer or oleophilic surface layer. Such addenda can include but are not limited to, silica, alumina, barium sulfate, titanium dioxide, kaolin, or other inorganic particulate materials, and various surfactants. The crosslinked hydrophilic inner layer generally contains no infrared radiation absorbing compound. That is, none of these compounds is purposely incorporated into the crosslinked hydrophilic inner layer formulation.

Oleophilic Surface Layer:

The lithographic printing plate precursor includes one or more non-crosslinked oleophilic polymers or polymeric binders that are considered the “primary” polymeric binders in the oleophilic surface (outermost) layer. The weight average molecular weight (M_{w}) of the useful primary polymeric binders is generally at least 5,000 and can be up to 500,000 and typically from about 10,000 to about 100,000. The optimal M_{w} can vary with the specific polymer and its use.

Useful non-crosslinked oleophilic polymers include but are not limited to, any oleophilic polymer (including copolymers) such as phenolic resins, poly(vinyl acetals), polyesters, polyvinyl aromatics (such as polystyrenes and poly(hydroxystyrenes)), that can be coated onto the crosslinked hydrophilic layer (or intermediate layer) and that by suitable formulation will exhibit the desired adhesion characteristics to those underlying layer(s) and also sufficient chemical resistance to the printing process (described below).

In general, any non-crosslinked oleophilic polymer or combination of non-crosslinked oleophilic polymers can be used in the oleophilic surface layer as long as at least one solvent resistance test is satisfied. These solvent resistance tests include the Butyl Cellusolve test, UV Wash test, Diacetone Alcohol test, and Heatset Fountain Solution test that are described below in the Examples. A particular non-crosslinked oleophilic polymer need not satisfy all of the tests although polymers that satisfy all four tests would provide optimal results.

In most embodiments, the non-crosslinked oleophilic polymers are poly(vinyl acetal) resins that comprise at least 15 mol % (based on total recurring units in resin) of randomly recurring units represented by the following Structure (Ia):

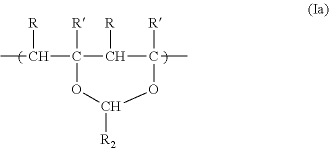

wherein R and R′ are independently hydrogen or a substituted or unsubstituted alkyl group (generally having 1 to 10 carbon atoms), a substituted or unsubstituted cycloalkyl group (having 5 to 10 carbon atoms in the ring structure), or a halo group (such as fluoro, chloro, or bromo). R₂ is an aryl group (such as phenyl, naphthyl, or anthryl) that is substituted with a cyclic imide group such as a cyclic aliphatic or aromatic imide group including but not limited to, maleimide, phthalimide, tetrachlorophthalimide, hydroxyphthalimide, carboxypthalimide, nitrophthalimide, chlorophthalimide, bromophthalimide, and naphthalimide groups. The aryl group of the cyclic aliphatic or aromatic imide group, or both the aryl and cyclic aliphatic or aromatic imide groups, are optionally further substituted with one or more substituents selected from the group consisting of hydroxyl, substituted or unsubstituted alkyl, substituted or unsubstituted alkoxy, and halo groups (such as fluoro and chloro), and any other group that does not adversely affect the properties of the cyclic imide group or the poly(vinyl acetal) in the oleophilic surface layer.

The poly(vinyl acetal) resins can also include randomly recurring units that are selected from one or more of the recurring units represented by the following Structures (Ib), (Ic), and (Id):

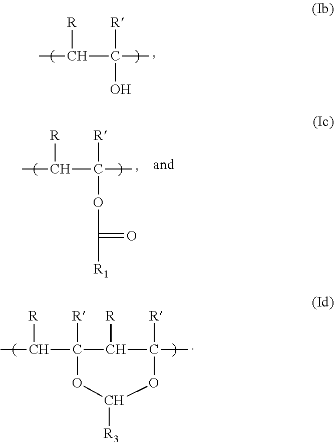

In all of these Structures, R and R′ are as defined above for Structure (Ia), but each recurring unit need not comprise the same R and R′ group as the other recurring units in the chain.

In Structure (Ic), R₁ is a substituted or unsubstituted linear or branched alkyl group having 1 to 12 carbon atoms (such as methyl, ethyl, n-propyl, n-butyl, n-pentyl, n-hexyl, chloromethyl, trichloromethyl, iso-propyl, iso-butyl, t-butyl, iso-pentyl, neo-pentyl, 1-methylbutyl, iso-hexyl, and dodecyl groups), a substituted or unsubstituted cycloalkyl having 5 to 10 carbon atoms in the carbocyclic ring (such as cyclopentyl, cyclohexyl, 4-methylcyclohexyl, and 4-chlorocyclohexyl), or a substituted or unsubstituted aryl group having 6 or 10 carbon atoms in the aromatic ring (such as phenyl, naphthyl, p-methylphenyl, and, p-chlorophenyl). Such groups can be substituted with one or more substituents such as alkyl, alkoxy, and halo, or any other substituent that a skilled worker would readily contemplate that would not adversely affect the performance of the polyvinyl acetal resin in the imageable element.

In Structure (Id), R₃ is an aryl group (such as phenyl, naphthyl, or anthracenyl group) that is unsubstituted or substituted with at least one hydroxy group and optionally a nitro group. Thus, R₃ can be a nitro-substituted phenol, nitro-substituted naphthol, or nitro-substituted anthracenol group, wherein the nitro group is generally in the meta-position relative to the aromatic carbon attached to the polymer backbone and the one or more hydroxy groups can be in the ortho, meta, or para positions relative to the aromatic carbon attached to the polymer backbone. The R₃ aryl group can have further substituents such as alkyl, alkoxy, or halo groups that do not adversely affect the properties of the aromatic group or the poly(vinyl acetal) in the oleophilic surface layer. R₃ is particularly a meta-nitro, ortho-phenol group relative to the aromatic carbon that is attached to the polymer backbone.

When recurring units represented by any of Structures (Ib), (Ic), and (Id) are present, in random order, the recurring units represented by Structure (Ib) can be present in an amount of at least 30 and up to and including 60 mol %, the recurring units represented by Structure (Ic) can be present in an amount of at least 1 and up to and including 15 mol %, and the recurring units represented by Structure (Id) can be present in an amount of at least 30 and up to and including 60 mol %, all based on the total recurring units in the poly(vinyl acetal).

The poly(vinyl acetal) resin can comprise the following recurring units, in random order, in the noted amounts, all based on the total recurring units in the resin:

Structure (Ia) recurring units of at least 20 and up to and including 100 mole %,

Structure (Ib) recurring units of at least 33 and up to and including 40 mol %,

Structure (Ic) recurring units of at least 2 and up to and including 5 mol %, and

Structure (Id) recurring units of at least 35 and up to and including 45 mol %.

The poly(vinyl acetal) resins useful in the oleophilic surface layer comprise at least recurring units represented by Structure (Ia) and optionally recurring units represented by Structures (Ib) through (Id) but such resins can also comprise randomly recurring units other than those defined by the illustrated recurring units and such additional recurring units would be readily apparent to a skilled worker in the art. Thus, the polymeric binders useful in this invention are not limited specifically to the recurring units defined by Structures (Ia) through (Id).

There also can be multiple types of recurring units from any of the defined classes of recurring units in Structures (Ia), (Ic), and (Id) with different substituents. For example, there can be multiple types of recurring units with different R and R′ groups, there can be multiple types of recurring units with different R₁ groups, there can be multiple types of recurring units with different R₂ groups, or there can be multiple types of recurring units with different R₃ groups. In addition, the number and type of recurring units in the primary polymeric binders are generally in random sequence, but blocks of specific recurring units can also be present unintentionally.

The primary polymeric binder is generally present in the oleophilic surface layer in an amount of at least 40 and up to and including 95 weight % (or typically at least 50 and up to and including 80 weight %) based on the total dry weight of the oleophilic surface layer.

The primary polymeric binders having pendant aryl groups (for example phenyl groups) that are substituted with a cyclic imide (such as a carboxy phthalimide group) on the aromatic ring can be prepared by acetalization of cyclic imide derivatives of aryl aldehydes with poly(vinyl alcohol) in the presence of acidic catalysts such as methanesulfonic acid in DMSO. For example, see the preparation of polymer MN24 below. Further details for preparing the poly(vinyl acetal) resins useful in this invention are provided in WO04/081662 (Memetea et al.) and U.S. Pat. Nos. 6,255,033, 6,541,181, and 7,723,012 (all Levanon et al.) that are incorporated herein by reference.

The primary polymeric binders described herein can be used alone or in admixture with other polymeric binders, identified herein as “secondary polymeric binders”. These additional polymeric binders include other poly(vinyl acetal)s that do not have recurring units represented by Structure (Ia). The type of the secondary polymeric binder that can be used together with the primary polymeric binder is not particularly restricted. Useful secondary polymeric binders include phenolic resins, including novolak resins such as condensation polymers of phenol and formaldehyde, condensation polymers of m-cresol and formaldehyde, condensation polymers of p-cresol and formaldehyde, condensation polymers of m-/p-mixed cresol and formaldehyde, condensation polymers of phenol, cresol (m-, p-, or m-/p-mixture) and formaldehyde, and condensation copolymers of pyrogallol and acetone. Further, copolymers obtained by copolymerizing compound comprising phenol groups in the side chains can be used. Mixtures of such polymeric binders can also be used.

Examples of other useful secondary polymeric binders include the following classes of polymers having an acidic group in (1) through (5) shown below on a main chain and/or side chain (pendant group).

(1) sulfone amide (—SO₂NH—R′),

(2) substituted sulfonamido based acid group (hereinafter, referred to as active imido group) [such as —SO₂NHCOR′, SO₂NHSO₂R′, —CONHSO₂R′],

(3) carboxylic acid group (—CO₂H),

(4) sulfonic acid group (—SO₃H), and

(5) phosphoric acid group (—OPO₃H₂).

R′ in the above-mentioned groups (1)-(5) represents hydrogen or a hydrocarbon group.

Other useful secondary polymeric binders include nitrocellulose, polyesters, and polystyrenes including poly(hydroxystyrenes).

The secondary polymeric binder can have a weight average molecular weight of at least 2,000 and a number average molecular weight of at least 500. Typically, the weight average molecular weight is from about 5,000 to about 300,000, the number average molecular weight is from about 800 to about 250,000, and the degree of dispersion (weight average molecular weight/number average molecular weight) is from about 1.1 to about 10.

Mixtures of the secondary polymeric binders can be used with the one or more primary polymeric binders. The secondary polymeric binder(s) can be present in an amount of at least 1 and up to and including 50 weight %, and typically at least 5 and up to and including 30 weight %, based on the dry weight of the total polymeric binders in the oleophilic surface layer.

The oleophilic surface layer typically also comprises one or more infrared radiation absorbing compounds that are typically sensitive to infrared radiation of at least 700 nm and up to and including 1400 nm and typically at least 750 nm and up to and including 1250 nm.

Useful infrared radiation absorbing compounds include pigments such as carbon blacks including but not limited to carbon blacks that are surface-functionalized with solubilizing groups are well known in the art. Carbon blacks that are grafted to hydrophilic, nonionic polymers, such as FX-GE-003 (manufactured by Nippon Shokubai), or which are surface-functionalized with anionic groups, such as CAB-O-JET® 200 or CAB-O-JET® 300 (manufactured by the Cabot Corporation) are also useful. Other useful carbon blacks are available from Cabot Billerica under the tradename Mogul. Other useful pigments include, but are not limited to, Heliogen Green, Nigrosine Base, iron (III) oxides, manganese oxide, Prussian Blue, and Paris Blue. The size of the pigment particles should not be more than the thickness of the oleophilic surface.

Examples of suitable IR dyes as infrared radiation absorbing compounds include but are not limited to, azo dyes, squarylium dyes, croconate dyes, triarylamine dyes, thioazolium dyes, indolium dyes, oxonol dyes, oxazolium dyes, cyanine dyes, merocyanine dyes, phthalocyanine dyes, indocyanine dyes, indotricarbocyanine dyes, hemicyanine dyes, streptocyanine dyes, oxatricarbocyanine dyes, thiocyanine dyes, thiatricarbocyanine dyes, merocyanine dyes, cryptocyanine dyes, naphthalocyanine dyes, polyaniline dyes, polypyrrole dyes, polythiophene dyes, chalcogenopyryloarylidene and bi(chalcogenopyrylo)-polymethine dyes, oxyindolizine dyes, pyrylium dyes, pyrazoline azo dyes, oxazine dyes, naphthoquinone dyes, anthraquinone dyes, quinoneimine dyes, methine dyes, arylmethine dyes, polymethine dyes, squarine dyes, oxazole dyes, croconine dyes, porphyrin dyes, and any substituted or ionic form of the preceding dye classes. Suitable dyes are described for example, in U.S. Pat. Nos. 4,973,572 (DeBoer), 5,208,135 (Patel et al.), 5,244,771 (Jandrue Sr. et al.), and 5,401,618 (Chapman et al.), and EP 0 823 327A1 (Nagasaka et al.).

Cyanine dyes having an anionic chromophore are also useful. For example, the cyanine dye can have a chromophore having two heterocyclic groups. In another embodiment, the cyanine dye can have from about two sulfonic acid groups, such as two sulfonic acid groups and two indolenine groups as described for example in U.S Patent Application Publication 2005-0130059 (Tao).

Near infrared absorbing cyanine dyes are also useful and are described for example in U.S. Pat. Nos. 6,309,792 (Hauck et al.), 6,264,920 (Achilefu et al.), 6,153,356 (Urano et al.), and 5,496,903 (Watanabe et al.). Suitable dyes can be formed using conventional methods and starting materials or obtained from various commercial sources including American Dye Source (Baie D'Urfe, Quebec, Canada) and FEW Chemicals (Germany). Other useful dyes for near infrared diode laser beams are described, for example, in U.S. Pat. No. 4,973,572 (noted above).

The infrared radiation absorbing compounds are generally present in the oleophilic surface layer at a dry coverage of at least 2 and up to and including 45 weight %, or typically in an amount of at least 25 and up to and including 40 weight %. The particular amount needed for this purpose would be readily apparent to one skilled in the art, depending upon the specific compound used. It is particularly useful to use a carbon black in the oleophilic surface layer in an amount of at least 25 and up to and including 35 weight % based on the dry weight of the layer.

The oleophilic surface layer is chemically bonded to the crosslinked hydrophilic inner layer at their interface in a suitable manner. For example, the chemical bonding is accomplished through covalent bonds, intermolecular bonds, or both covalent bonds and intramolecular bonds. For example, the chemical bonding can be accomplished through crosslinking agents such as those that are used to crosslink the hydrophilic binders in the crosslinked hydrophilic inner layer. For example, such crosslinking agents can be are selected from the group consisting of zirconium ammonium carbonate, ethane-1,2-dione, tetraethyl orthosilicate, tetramethyl orthosilicate, terephthalic aldehyde, and a melamine crosslinking agent. Thus, while there can be crosslinking at the interface of the two layers, the oleophilic surface layer is generally non-crosslinked throughout.

Alternatively, a crosslinkable polymer can be used to adhere the two layers at the interface although the oleophilic surface layer is not intended to include a crosslinked polymer uniformly distributed therein. The crosslinkable polymer can be incorporated into the crosslinked hydrophilic inner layer formulation so that crosslinking can occur at the interface.

The oleophilic surface layer can also include one or more additional compounds that are colorant dyes, or UV or visible light-sensitive components. Useful colorant dyes include triarylmethane dyes such as ethyl violet, crystal violet, malachite green, brilliant green, Victoria blue B, Victoria blue R, and Victoria pure blue BO, BASONYL® Violet 610 and D11 (PCAS, Longjumeau, France). These compounds can act as contrast dyes that distinguish the non-exposed (non-imaged) regions from the exposed (imaged) regions in the lithographic printing plate. When a colorant dye is present in the oleophilic surface layer, its amount can vary widely, but generally it is present in an amount of at least 0.5 and up to and including 30 weight %.

The oleophilic surface layer can also include other addenda that would be useful for coating properties, coated layer physical properties, and adhesion to the underlying layer such as small organic molecules, oligomers, and surfactants. These additives can be generally present in the oleophilic surface layer in an amount of at least 1 and up to and including 30 weight %, or typically at least 2 and up to and including 20 weight %. The oleophilic surface layer can further include a variety of additives including dispersing agents, humectants, biocides, plasticizers, surfactants for coatability or other properties, viscosity builders, fillers and extenders, pH adjusters, drying agents, defoamers, preservatives, antioxidants, rheology modifiers or combinations thereof, or any other addenda commonly used in the lithographic art, in conventional amounts.

The oleophilic surface layer is generally present at a dry coverage of at least 0.7 and up to and including 2.5 g/m².

### Intermediate Layer

The lithographic printing plate precursors can have an intermediate layer between and adhering the crosslinked hydrophilic inner layer and the oleophilic surface layer. This intermediate layer is relatively thin, for example having a dry coverage of at least 0.1 and up to and including 0.5 g/m². This intermediate layer also generally includes a crosslinking agent as described above for the crosslinked hydrophilic inner layer, which crosslinking agent serves to improve adherence of the intermediate layer to the overlying oleophilic surface layer and underlying crosslinked hydrophilic inner layer at the respective interfaces. An infrared radiation absorbing compound can be included in this intermediate layer in addition to or alternatively to, the infrared radiation absorbing compound in the cleophilic surface layer.

### Preparation of Lithographic Printing Plate Precursors

The positive-working lithographic printing plate precursors used in this invention can be prepared by applying a crosslinked hydrophilic inner layer formulation (as described above) in suitable solvents to the surface of the substrate (and any other hydrophilic layers provided thereon) using conventional coating or lamination methods. Thus, the crosslinked hydrophilic inner layer formulation can be applied by dispersing or dissolving the desired components (for example crosslinkable hydrophilic polymers and crosslinking agents) in one or more suitable coating solvents. The resulting formulation is applied to the substrate using suitable equipment and procedures, such as spin coating, knife coating, gravure coating, die coating, slot coating, bar coating, wire rod coating, roller coating, or extrusion hopper coating. The formulation can also be applied by spraying onto a suitable support (such as an on-press printing cylinder).

The crosslinked hydrophilic inner layer formulation can include at least 2% and up to and including 50% of one of or more crosslinking agents, based on the total solids of the formulation. For example, the crosslinking agent can be selected from the group consisting of zirconium ammonium carbonate, ethane-1,2-dione, tetraethyl orthosilicate, tetramethyl orthosilicate, terephthalic aldehyde, and a melamine crosslinking agent.

In certain embodiments, the inner layer formulation comprises a poly(vinyl alcohol) that is crosslinked during drying, for example that is crosslinked during the drying step using zirconium ammonium carbonate, ethane-1,2-dione, tetramethyl orthosilicate, or tetraethyl orthosilicate as a crosslinking agent.

After drying, the dry coating weight for the crosslinked hydrophilic inner layer is at least 0.5 and up to and including 4 g/m² and typically at least 1 and up to and including 2.5 g/m².

The selection of solvents used to coat the crosslinked hydrophilic inner layer formulation depends upon the nature of the hydrophilic polymeric binders, crosslinking agents, and other polymeric materials and non-polymeric components in the formulation. Generally, the crosslinked hydrophilic inner layer formulation is coated out of one or more solvents that can dissolve hydrophilic polymers including but not limited to, water, water-miscible alcohols, and ketones such as acetone, and mixtures thereof.

If an intermediate layer is to be present, an intermediate layer formulation is prepared and applied to the crosslinked hydrophilic inner layer (after it is dried) in a similar fashion using appropriate coating solvents for the polymers, radiation absorbing compounds, crosslinking agents that can be present, and any other optional components described above. Heating the intermediate layer formulation when it is oven-dried or when the oleophilic surface layer formulation is applied and dried can affect chemical bonding of that layer at the interfaces with the crosslinked hydrophilic inner layer and the oleophilic surface layer formulation that is applied later.

For example, an intermediate layer formulation can be applied to the dry hydrophilic inner layer (before step B or application of the oleophilic surface layer formulation) to provide, upon drying, an intermediate layer having a dry coverage of at least 0.1 and up to and including 0.5 g/m². This intermediate layer formulation can comprise a crosslinking agent and optionally an infrared radiation absorbing compound.

The oleophilic surface layer formulation is prepared by dissolving or dispersing the poly(vinyl acetal), any other polymeric binders, an infrared radiation absorbing compound, and any other optional addenda in suitable solvents including but not limited to, acetone, methyl ethyl ketone, or another ketone, tetrahydrofuran, 1-methoxy-2-propanol, N-methylpyrrolidone, 1-methoxy-2-propyl acetate, y-butyrolactone, and mixtures thereof using conditions and techniques well known in the art. After application of the formulation to either the dried intermediate layer or the dried crosslinked hydrophilic inner layer, the oleophilic surface layer formulation is also dried to effect chemical bonding of the resulting oleophilic surface layer with the layer below, which in most embodiments, is the crosslinked hydrophilic inner layer.

In particular, the oleophilic surface layer formulation further comprises an infrared radiation absorbing compound as described above.

Representative methods for preparing positive-working imageable elements are described below in the examples.

After all of the layer formulations are dried on the substrate (that is, the coatings are dry to the touch), the lithographic printing plate precursor can be heat treated at a temperature of at least 40° C. and up to and including 90° C. (typically of at least 50° C. and up to and including 70° C.) for at least 4 hours and typically for at least 20 hours. The maximum heat treatment time can be several days, but the optimal time and temperature for the heat treatment can be readily determined by routine experimentation. This heat treatment can also be known as a “conditioning” step. Such treatments are described for example, in EP 823,327 (Nagaska et al.) and EP 1,024,958 (McCullough et al).

It can also be desirable that during the heat treatment, the lithographic printing plate precursor is wrapped or encased in a water-impermeable sheet material to represent an effective barrier to moisture removal from the precursor. This sheet material is sufficiently flexible to conform closely to the shape of the precursor (or stack of multiple precursors) and is generally in close contact with the precursors. For example, the water-impermeable sheet material can be sealed around the edges of the lithographic printing plate precursor(s). Such water-impermeable sheet materials include polymeric films or metal foils that are sealed around the edges of the precursors or stack thereof. More details of this process are provided in U.S. Pat. No. 7,175,969 (Ray et al.).

A stack of at least 10 and up to 1000 lithographic printing plate precursors can then be stored or shipped in appropriate containers for customer use with the method of this invention.

### Imaging and Printing

The lithographic printing plate precursors used in this invention can have any useful form including, but not limited to, printing plate precursors, printing cylinder precursors, printing sleeve precursors and printing tape precursors (including flexible printing webs). In most embodiments, the invention is using lithographic printing plate precursors that are designed to form lithographic printing plates.

Lithographic printing plate precursors can be of any useful size and shape (for example, square or rectangular) having the requisite layers disposed on a suitable substrate. Printing cylinders and sleeves are known as rotary printing members having the substrate and requisite layers in a cylindrical form. Hollow or solid metal cores can be used as substrates for printing sleeves.

During use, the lithographic printing plate precursors are exposed to a suitable source of radiation such as near-IR and infrared radiation, depending upon the infrared radiation absorbing compound that can be present in the lithographic printing plate precursor, for example at a wavelength of at least 700 and up to and including 1500 nm. For most embodiments, imaging is carried out using an infrared or near-infrared laser at a wavelength of at least 700 and up to and including 1200 nm. The laser used to expose the imaging member can be a diode laser, because of the reliability and low maintenance of diode laser systems, but other lasers such as gas or solid-state lasers may also be used. The combination of power, intensity and exposure time for laser imaging would be readily apparent to one skilled in the art.

The imaging apparatus can function solely as a platesetter or it can be incorporated directly into a lithographic printing press. Printing can commence immediately after imaging without contact with any solutions. The imaging apparatus can be configured as a flatbed recorder or as a drum recorder, with the lithographic printing plate precursor mounted to the interior or exterior cylindrical surface of the drum. A useful imaging apparatus is available as models of Kodak Trendsetter imagesetters available from Eastman Kodak Company (Burnaby, British Columbia, Canada) that contain laser diodes that emit near infrared radiation at a wavelength of about 830 nm. Other suitable imaging sources include the Crescent 42T Platesetter that operates at a wavelength of 1064 nm (available from Gerber Scientific, Chicago, Ill.) and the Screen PlateRite 4300 series or 8600 series platesetter (available from Screen, Chicago, Ill.). Additional useful sources of radiation include direct imaging presses that can be used to image an element while it is attached to the printing plate cylinder. An example of a suitable direct imaging printing press includes the Heidelberg SM74-DI press (available from Heidelberg, Dayton, Ohio).

IR imaging exposure energy can be from about 1 J/cm², or typically at least 1 and up to and including 4 J/cm².

While laser imaging is usually practiced, imaging can be provided by any other means that provides thermal energy in an imagewise fashion. For example, imaging can be accomplished using a thermoresistive head (thermal printing head) in what is known as “thermal printing”, described for example in U.S. Pat. No. 5,488,025 (Martin et al.). Thermal print heads are commercially available (for example, as Fujitsu Thermal Head FTP-040 MCS001 and TDK Thermal Head F415 HH7-1089).

Imaging is generally carried out using direct digital imaging. The image signals are stored as a bitmap data file on a computer. Such data files may be generated by a raster image processor (RIP) or other suitable means. The bitmaps are constructed to define the hue of the color as well as screen frequencies and angles.

Imaging of the lithographic printing plate precursor produces a latent image of imaged (ablated) and non-imaged (non-ablated) regions. Substantially the entire oleophilic surface layer and perhaps a small portion of the crosslinked hydrophilic inner layer are ablated or physically removed in the imaged regions during imaging. If an intermediate layer is present, perhaps a small portion of it is also ablated or, when it comprises an infrared radiation absorbing compound, the entire intermediate layer can be ablated.

The ablated material can be removed from the imaged lithographic printing plate precursor and its environment using known means such as vacuum, or wiping with a dry or moist cloth (for example, dry cleaning) before the imaged precursor is used for printing. In particular, the ablated image on the imaged precursor can be dry cleaned before being used for lithographic printing. In other embodiments, the ablated image is used for lithographic printing without dry cleaning and without contact with any solution. The important aspect of this invention is that wet processing such as development with water or a developer solution, gumming, or water rinsing is not required before the imaged precursor is used for lithographic printing. Thus, it is an important advantage that lithographic printing can be carried out immediately after the lithographic printing plate precursor is imaged by ablation.

During the present invention, ablation so completely removes the oleophilic surface layer that very little debris (trace amounts) in the form of very small particles are left due to electrostatic attraction to the outer surface of the lithographic printing plate. These small particles are generally removed in the on-press fountain solution and lithographic printing ink. The background in printed images is very clear at the beginning of the print run. Thus, with the present invention, it is possible to achieve literally processless lithographic printing plates using ablation for imaging.

The imaged lithographic printing plates can be used for lithographic printing on any suitable printing apparatus using known fountain solutions and lithographic printing inks for as many impressions that are desired. The lithographic printing plate can be used in a single printing run for its entire printing life, or printing can be stopped and the printing plate cleaned before resuming lithographic printing.

The present invention provides at least the following embodiments and combinations thereof, but other combinations of features are considered to be within the present invention as a skilled artisan would appreciate from the teaching of this disclosure:

1. A method of preparing a lithographic printing plate ready for lithographic printing comprising:

exposing a positive-working lithographic printing plate precursor to ablating infrared radiation of an energy of at least 1 J/cm² to form an ablated image in a lithographic printing plate ready for lithographic printing, wherein the positive-working lithographic printing plate precursor comprises a hydrophilic aluminum substrate, and comprises on the substrate:

a crosslinked hydrophilic inner layer, and

an oleophilic surface layer that is chemically bonded to the crosslinked hydrophilic inner layer, the oleophilic surface layer comprising at least one non-crosslinked oleophilic polymer.

2. The method of embodiment 1 wherein the oleophilic surface layer is chemically bonded to the crosslinked hydrophilic inner layer through covalent bonds, intermolecular bonds, or both covalent and intermolecular bonds.

3. The method of embodiment 1 or 2 wherein the oleophilic surface layer has solvent resistance as determined using the Butyl Cellusolve test.

4. The method of any of embodiments 1 to 3 wherein the oleophilic surface layer has solvent resistance as determined using the UV Wash test.

5. The method of any of embodiments 1 to 4 wherein the oleophilic surface layer has solvent resistance as determined using the Diacetone Alcohol test.

6. The method of any of embodiments 1 to 5 wherein the oleophilic surface layer has solvent resistance as determined using the Heatset Fountain Solution test.

7. The method of any of embodiments 1 to 6 wherein the at least one non-crosslinked oleophilic polymer in the oleophilic surface layer is a poly(vinyl acetal) polymer.

8. The method of any of embodiments 1 to 7 wherein the at least one non-crosslinked oleophilic polymer in the oleophilic surface layer is a poly(vinyl acetal) polymer comprising at least 15 mol % recurring units, based on total recurring units, represented by the following Structure (Ia):

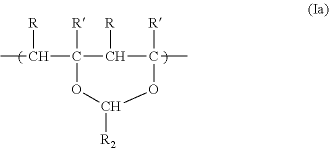

wherein R and R′ are independently hydrogen or a substituted or unsubstituted alkyl group, a substituted or unsubstituted cycloalkyl group, or halo group, and R₂ is an aryl group that is substituted with a cyclic imide group, which aryl group or cyclic imide group can be further substituted.

9. The method of embodiment 8 wherein R₂ is a phenyl or naphthyl group that has a cyclic aliphatic or aromatic imide group selected from the group consisting of maleimide, phthalimide, tetrachlorophthalimide, hydroxyphthalimide, carboxypthalimide, nitrophthalimide, chlorophthalimide, bromophthalimide, and naphthalimide groups, wherein the phenyl, naphthyl, or cyclic aliphatic or aromatic imide group is optionally further substituted with one or more substituents selected from the group consisting of hydroxyl, alkyl, alkoxy, and halo groups.

10. The method of embodiment 8 or 9 wherein the at least one non-crosslinked oleophilic polymer in the oleophilic surface layer is a polyvinyl acetal) polymer further comprising randomly occurring recurring units represented by any of the following Structures (Ib) through (Id):

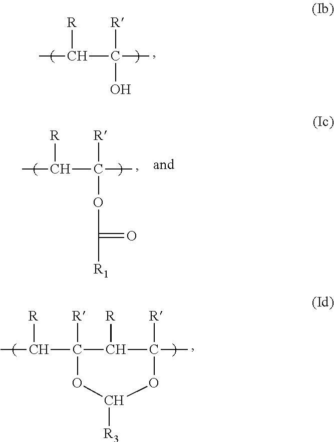

wherein R and R′ are independently hydrogen or a substituted or unsubstituted alkyl group, a substituted or unsubstituted cycloalkyl group, or a halo group,

R₁ is a substituted or unsubstituted linear or branched alkyl group having 1 to 12 carbon atoms, a substituted or unsubstituted cycloalkyl having 5 to 10 carbon atoms in the carbocyclic ring, or a substituted or unsubstituted aryl group having 6 or 10 carbon atoms in the aromatic ring, and

R₃ is an aryl group that is unsubstituted or substituted with at least one hydroxy group and optionally with a nitro group.

11. The method of embodiment 10 wherein R₃ is a nitro-substituted phenol, nitro-substituted naphthol, or nitro-substituted anthracenol.

12. The method of any of embodiments 1 to 11 wherein the oleophilic surface layer further comprises an infrared radiation absorbing compound.

13. The method of any of embodiment 1 to 12 wherein the oleophilic surface layer further comprises a carbon black infrared radiation absorbing compound.

14. The method of any of embodiments 1 to 13 wherein the oleophilic surface layer is chemically bonded to the crosslinked hydrophilic inner layer using a crosslinking agent that is selected from the group consisting of zirconium ammonium carbonate, ethane-1,2-dione, tetraethyl orthosilicate, tetramethyl orthosilicate, terephthalic aldehyde, and a melamine.

15. The method of any of embodiments 1 to 14 wherein the crosslinked hydrophilic inner layer comprises a crosslinked poly(vinyl alcohol).

16. The method of any of embodiments 1 to 15 wherein the crosslinked hydrophilic inner layer comprises a crosslinked poly(vinyl alcohol) obtained using zirconium ammonium carbonate, ethane-1,2-dione, tetramethyl orthosilicate, or tetraethyl orthosilicate as a crosslinking agent.

17. The method of any of embodiments 1 to 16 wherein the crosslinked hydrophilic inner layer comprises a crosslinked polymeric binder in an amount of at least 50 weight % and up to and including 100 weight % based on the total crosslinked hydrophilic inner layer dry weight.

18. The method of any of embodiments 1 to 17 wherein the crosslinked hydrophilic inner layer has a dry coverage of at least 0.5 and up to and including 4 g/m².

19. The method of any of embodiments 1 to 18 wherein the positive-working lithographic printing plate precursor further comprises an intermediate layer between and adhering the crosslinked hydrophilic inner layer and the oleophilic surface layer, the intermediate layer having a dry coverage of at least 0.1 and up to and including 0.5 g/m².

20. The method of embodiment 19 wherein the intermediate layer comprises a crosslinking agent and optionally an infrared radiation absorbing compound.

21. The method of any of embodiments 1 to 20 wherein the oleophilic surface layer has a dry coverage of at least 0.7 and up to and including 2.5 g/m².

22. The method of claim 1 wherein exposing is carried out at an energy level of at least 1 and up to and including 4 J/cm².

23. The method of any of embodiments 1 to 22, further comprising:

without intermediate contact with a solution, using the lithographic printing plate having the ablated image for lithographic printing.

24. The method of embodiment 23 wherein the lithographic printing plate having the ablated image is dry cleaned before being used for the lithographic printing.

25. The method of embodiment 23 comprising using the lithographic printing plate having the ablated image for lithographic printing without dry cleaning.

26. A method for preparing a lithographic printing plate precursor comprising:

to a hydrophilic aluminum substrate, applying an inner layer formulation comprising a hydrophilic polymer and a crosslinking agent for the hydrophilic polymer and drying to form a crosslinked hydrophilic inner layer,

applying an oleophilic surface layer formulation comprising at least one non-crosslinked oleophilic polymer to form an oleophilic surface layer on the hydrophilic inner layer,

drying the applied oleophilic surface layer to effect chemical bonding of the oleophilic surface layer to the crosslinked hydrophilic inner layer.

27. The method of embodiment 26 wherein the crosslinking agent is present in the inner layer formulation in an amount of at least 2% and up to and including 50% solids based on the inner layer formulation weight.

28. The method of embodiment 26 or 27 wherein the at least one non-crosslinked oleophilic polymer is a poly(vinyl acetal) polymer comprising recurring units that comprise an aryl group that is substituted with a cyclic imide group.

29. The method of any of embodiments 26 to 28 wherein the at least one non-crosslinked oleophilic polymer in the oleophilic surface layer formulation is a poly(vinyl acetal) polymer comprising at least 15 mol % of recurring units represented by the following Structure (Ia):

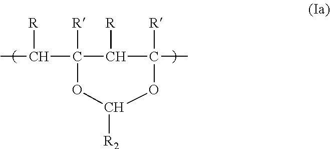

wherein R and R′ are independently hydrogen or a substituted or unsubstituted alkyl group, a substituted or unsubstituted cycloalkyl group, or halo group, and R₂ is an aryl group that is substituted with a cyclic imide group, which aryl or cyclic imide group can be further substituted.

30. The method of any of embodiments 26 to 29 wherein the crosslinking agent is selected from the group consisting of zirconium ammonium carbonate, ethane-1,2-dione, tetraethyl orthosilicate, tetramethyl orthosilicate, terephthalic aldehyde, and a melamine.

31. The method of any of embodiments 26 to 30 wherein the inner layer formulation comprises a poly(vinyl alcohol) that is crosslinked during drying.

32. The method of embodiment 31 wherein the inner layer formulation comprises a poly(vinyl alcohol) that is crosslinked during the drying step using zirconium ammonium carbonate, ethane-1,2-dione, tetramethyl orthosilicate, or tetraethyl orthosilicate as a crosslinking agent.

33. The method of any of embodiments 26 to 32 further comprising applying an intermediate layer formulation to the wet hydrophilic inner layer between steps A and B, to provide upon drying, an intermediate layer having a dry coverage of at least 0.1 and up to and including 0.5 g/m².

34. The method of embodiment 33 wherein the intermediate layer formulation comprises a crosslinking agent and optionally an infrared radiation absorbing compound.

35. The method of any of embodiments 26 to 34 wherein the oleophilic surface layer formulation further comprises an infrared radiation absorbing compound in an amount to provide a dry coverage of at least 2 and up to and including 45 weight %.

The following Examples are provided to illustrate the practice of this invention and are not meant to be limiting in any manner. In these examples, the following components were used to prepare the lithographic printing plate precursors. Unless otherwise indicated, the components are available from Aldrich Chemical Company (Milwaukee, Wis.):

ADS830WS is a near infrared radiation absorbing dye that can be obtained from American Dye Source, Inc.

Bacote 20 is ammonium zirconyl carbonate 50% solution in water that can be obtained from MeI Chemicals (Manchester, UK).

BF-03 represents a poly(vinyl alcohol), 98% hydrolyzed (Mw=15,000) that was obtained from Chang Chun Petrochemical Co. Ltd. (Taiwan).

Celvol® 125 is a poly(vinyl alcohol), 99.3% hydrolyzed, average molecular weight 124,000 that can be obtained from Celanese Chemicals.

DMSO represents dimethylsulfoxide.

Glyoxal solution is a 40 weight % solution of ethane-1,2-dione in water.

MEK represents methyl ethyl ketone.

Mogul® L is a carbon black powder that can be obtained from Cabot Billerica.

MSA represents methanesulfonic acid (99%).

PM represents 1-methoxy-2-propanol, can be obtained as Arcosolve® available from LyondellBasell industries (the Netherlands).

TEA represents triethanolamine.

Triton® X100 is a nonionic polyethylene glycol octylphenol ether surfactant that can be obtained from VWR International (BDH, Lutterworth, UK).

A carboxy-substituted 4-phthalimidobenzaldehyde, IUPAC name 2-(4-formylphenyl)-1,3-dioxoisoindoline-5-carboxylic acid (Compound I) was prepared as follows:

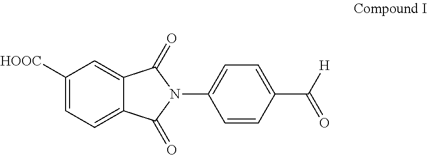

4-Aminobenzaldehyde (10 g) and 1,2,4-benzenetricarboxylic anhydride (15.86 g) were added to a 500 ml round bottom glass vessel equipped with a magnetic stirrer. Then, 350 g of acetic acid was added to the reaction vessel. The mixture was heated to the reflux while being stirred for 8 hours. The reaction mixture was chilled to room temperature. The precipitated product was filtered off, washed on the filter with water and alcohol, and dried. The yield of Compound I was 80% with a m.p. of 317° C.

### Preparation of Polymer MN-24

BF-03 (10.14 g) was added to a reaction vessel fitted with a water-cooled condenser, a dropping funnel and thermometer, containing DMSO (140 g). With continual stirring, the mixture was heated for 30 minutes at 80° C. until it became a clear solution. The temperature was then adjusted at 60° C. and MSA (0.88 g) was added. 2-(4-Formylphenyl)-1,3-dioxoisoindoline-5-carboxylic acid (10.00 g) in DMSO (20 g) was added to the reaction mixture and it was kept for 150 minutes at 85° C. Then, 2-hydroxy-5-nitro benzaldehyde (5-nitro-salicylic aldehyde, 8.87 g) and DMSO (20 g) were added to the reaction mixture that was then kept for 1 hour at 85° C. The reaction mixture was then diluted with DMSO (40 g) and anisole (55 g) and vacuum distillation was started. The anisole:water azeotrope was distilled out from the reaction mixture (less than 0.1% of water remained in the solution). The reaction mixture was chilled to room temperature and was neutralized with TEA (1 g) dissolved in DMSO (90 g), then blended with 1.8 kg of water. The resulting precipitated polymer was washed with water, filtered, and dried in vacuum for 24 hours at 60° C. to obtain 25.2 g of dry Polymer MN-24.

### Preparation of Polymer MN-31

BF-03 (10.14 g) was added to a reaction vessel fitted with a water-cooled condenser, a dropping funnel and thermometer, containing DMSO (140 g). With continual stirring, the mixture was heated for 30 minutes at 80° C. until it became a clear solution. The temperature was then adjusted at 60° C. and MSA (0.88 g) was added. 2-(4-Formylphenyl)-1,3-dioxoisoindoline-5-carboxylic acid (6.67 g) in DMSO (20 g) was added to the reaction mixture that was kept for 150 min at 85° C. Then, 2-hydroxy-5-nitro benzaldehyde (5-nitro-salicylic aldehyde, 6.60 g) and DMSO (20 g) were added to the reaction mixture that was kept for 1 hour at 85° C. The reaction mixture was then diluted with DMSO (40 g) and anisole (55 g), and vacuum distillation was started. The anisole:water azeotrope was distilled out from the reaction mixture (less than 0.1% of water remained in the solution). The reaction mixture was chilled to room temperature and was neutralized with TEA (1 g) dissolved in DMSO (90 g), then blended with 1.8 kg of water. The resulting precipitated polymer was washed with water, filtered, and dried in vacuum for 24 hours at 60° C. to obtain 20.6 g of dry Polymer MN-31.

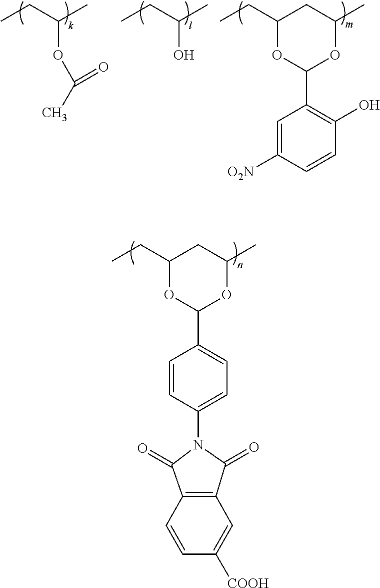

Recurring units in Polymers MN-24 and MN-31-in random order

The polymer binder MN-24 was derived from poly(vinyl alcohol) using 2% original acetate and its free OH groups were converted to acetals of carboxy substituted 4-phthalimidobenzaldehyde and 5-nitrosalicylic aldehyde at 30%, and 47%, respectively.

The polymer binder MN-31 was derived from poly(vinyl alcohol) using 2% original acetate and its free OH groups were converted to acetals of carboxy substituted 4-phthalimidobenzaldehyde and 5-nitrosalicylic aldehyde at 20%, and 35%, respectively.

The lithographic printing plate precursors described for this invention comprised an infrared radiation-sensitive oleophilic surface layer coated onto a crosslinked hydrophilic inner layer that was applied to an anodized and chemically treated aluminum substrate as described below.

### Invention Example 1

Lithographic printing plate precursors were prepared using the hydrophilic inner layer formulation containing the following components:

| Crosslinked Hydrophilic | | |
|---|---|---|
| Inner Layer Formulation | Weight (g) | Dry Weight % |
| Celvol ® 125 * PVA | 43.443 | 61.65 |
| Bacote 20 ** crosslinking | 1.391 | 24.68 |
| agent | | |
| Glycerol | 0.0756 | 2.68 |
| Triton ® X100 surfactant | 0.2707 | 0.96 |
| Water | 4.5365 | 0 |
| ADS830WS | 0.2827 | 10.03 |

* 4 weight % of PVA in water
** 50 weight % of ammonium zirconium carbonate in water

This hydrophilic inner layer formulation was applied to an electrochemically roughened and anodized aluminum substrate that had been subjected to post-treatment with an aqueous solution of sodium phosphate/sodium fluoride using known procedures and the coating was dried for 3 minutes at 145° C. in an oven to provide a dry coating weight of about 1.7 g/m². Onto this dried layer was coated an oleophilic surface layer formulation that was prepared by milling for 3 days (with metal balls) contained following components (of Part A) that were then diluted before coating with the solvents mixture of part B:

| Oleophilic Surface Layer | | |
|---|---|---|
| Formulation | Weight (g) | Dry Weight % |
| Part A - Milled base | | |
| Polymer MN-24 | 4.053 | 65 |
| MEK | 8.709 | 0 |
| PM | 16.175 | 0 |
| Mogul ® L carbon black | 2.182 | 35 |
| Part B - Solvents added to | | |
| Part A after milling | | |
| MEK | 1.004 | 0 |
| PM | 1.864 | 0 |

The oleophilic surface layer formulation was dried for 4 minutes at 170° C. in an oven to provide a dry coating weight of about 1.5 g/m².

The resulting lithographic printing plate precursor was exposed on a Kodak® Thermo Flex 400, 1 Watt imager in a range of energies of 1000 mJ/cm² to 2400 mJ/cm² and then dry cleaned with a cotton pad. The imaged lithographic printing plate precursor was then mounted onto a Ryobi 520HX printing press and 20,000 impressions were made showing good image quality after on-press development. A white printed background was obtained, corresponding to a fully imaged area on the lithographic printing plate. This result was observed from the beginning of the printing test until the end of the printing test and at 1000 mJ/cm² (and above). Signs of wear, of the fine features in particular (5% dots at 200 lpi screen), were seen starting from about 10,000 impressions.

The imaged areas on the lithographic printing plate were almost completely clean after imaging, so the dry cleaning step used after imaging, removed only trace amounts of debris. If no dry cleaning was carried out after imaging, the trace amounts of debris left on the imaged printing plate precursor were easily removed by the fountain solution on press. Indeed, fully imaged areas that were not dry cleaned, printed white backgrounds. Therefore, with this system, it is possible to achieve processless lithographic printing plates using ablation for imaging.

### Invention Example 2

Lithographic printing plate precursors were prepared as described in Invention Example 1, but the following oleophilic surface layer formulation was used to form the oleophilic surface layer:

| Oleophilic Surface Layer | | |
|---|---|---|
| Formulation | Weight (g) | Dry Weight % |
| Part A - Milled base | | |
| Polymer MN-31 | 4.053 | 65 |
| MEK | 8.709 | 0 |
| PM | 16.175 | 0 |
| Mogul ® L carbon black | 2.182 | 35 |
| Part B - Solvents added to | | |
| Part A after milling | | |
| MEK | 1.004 | 0 |
| PM | 1.864 | 0 |

The oleophilic surface layer formulation described above was applied and dried for 4 minutes at 170° C. in an oven to provide a dry coverage of about 1.5 g/m².

The resulting lithographic printing plate precursor was exposed using a Kodak® Thermo Flex 400, 1 Watt imager in a range of energies of 1000 mJ/cm² to 2400 mJ/cm² and dry cleaned with a cotton pad. The imaged precursor was then mounted onto a Ryobi 520HX printing press and 20,000 impressions were made showing good image quality. As in Invention Example 1, a white printed background was obtained, corresponding to a fully imaged area on the lithographic printing plate. This result was observed from the beginning of the printing test until the end of the test and already at 1000 mJ/cm² (and higher). Signs of wear of the fine features in particular (5% dots at 200 lpi screen) were seen starting from about 10,000 impressions.

The imaged areas on the lithographic printing plate were almost completely clean after imaging, so the dry cleaning step that followed removed only trace amounts of debris. If no dry cleaning was used after imaging, the trace amounts of debris left on the imaged lithographic printing plate precursor were easily removed by the fountain solution on the printing press. Indeed, fully imaged areas that were not dry cleaned printed white background. Therefore, with this imaging system, it is possible to achieve processless lithographic printing plates using ablation for imaging.

### Invention Example 3

Lithographic printing plate precursors were prepared as described above in Invention Example 1 but the following oleophilic surface layer formulation was used to form the imageable oleophilic surface layer:

| Oleophilic Surface Layer Formulation | Weight (g) | Dry Weight % |
|---|---|---|
| Part A - Milled base | | |
| Polymer MN-24 | 3.667 | 50 |
| MEK | 8.709 | 0 |
| PM | 16.175 | 0 |
| Mogul ® L carbon black | 2.567 | 35 |
| Part B - Solvents, cross linker and thermal | | |
| generated acid catalyst were added to Part | | |
| A after milling | | |
| MEK | 2.723 | 0 |
| PM | 5.057 | 0 |
| Cyclohexyl p-toluene sulfonate | 0.587 | 8 |
| Terephthalic aldehyde | 0.514 | 7 |

The oleophilic surface layer formulation described above was applied and dried for 4 minutes at 170° C. in an oven to provide a dry coverage of about 1.5 g/m².

The resulting lithographic printing plate precursor was exposed using a Kodak® Thermo Flex 400, 1 Watt imager in a range of energies of 1000 mJ/cm² to 2400 mJ/cm² and dry cleaned with a cotton pad. The imaged precursor was then mounted onto a Ryobi 520HX press and 20,000 impressions were made showing good image quality. A white printed background was obtained, corresponding to a fully imaged area on the printing plate. This result was observed from the beginning of the printing test until the end of the test and already at 1000 mJ/cm² (and above). Signs of wear of fine features in particular (5% dots at 200 lpi screen) were seen starting from about 10,000 impressions. Compared with the results obtained in Invention Example 1, similar adhesion concerns and wear were observed on press. In this example (using Polymer-MN-24), use of the terephthalic aldehyde crosslinking agent did not lead to a significant improvement to adhesion between the two layers on the lithographic printing plate.

The imaged areas on the lithographic printing plate were almost completely clean after imaging, so the dry cleaning step that followed removed only trace amounts of debris. If no dry cleaning was applied after imaging, the trace amounts of debris left on the lithographic printing plate after imaging were easily removed by the fountain solution on the printing press. Indeed, fully imaged areas that were not dry cleaned printed white background. Therefore, with this system it is possible to achieve literally processless lithographic printing plates using ablation for imaging.

### Invention Example 4

Lithographic printing plate precursors were prepared as described above in Invention Example 1, but the following imageable oleophilic surface formulation was used:

| Oleophilic Surface Layer | | |
|---|---|---|
| Formulation | Weight (g) | Dry Weight % |
| Part A - Milled base | | |
| Polymer MN-31 | 3.667 | 50 |
| MEK | 8.709 | 0 |
| PM | 16.175 | 0 |
| Mogul ® L carbon black | 2.567 | 35 |
| Part B - Solvents, cross linker and | | |
| thermal generated acid catalyst were | | |
| added to Part A after milling | | |
| MEK | 2.723 | 0 |
| PM | 5.057 | 0 |
| Cyclohexyl p-toluene sulfonate | 0.587 | 8 |
| Terephthalic aldehyde | 0.514 | 7 |

The oleophilic surface formulation was applied and dried for 4 minutes at 170° C. in an oven to provide a dry coverage of about 1.5 g/m².

The resulting lithographic printing plate precursor was exposed onto a Kodak Thermo Flex 400, 1 Watt imager in a range of energies of 1000 ml/cm² to 2400 mJ/cm² and dry cleaned with a cotton pad. The imaged precursor was then mounted onto a Ryobi 520HX press and 20,000 impressions were made showing good image quality. A white printed background obtained corresponding to a fully imaged area on the lithographic printing plate. This result was observed from the beginning of the print test until the end of the test as soon as 1100 mJ/cm² (and above). Signs of wear of fine features in particular (5% dots at 200 lpi screen) were seen towards the end of the printing test. At this stage (20,000 impressions), wear was less severe compared with that found with Invention Examples 2 and 3 even at about 10,000 impressions. In this case (using polymer MN-31), the use of the terephthalic aldehyde crosslinking agent caused a significant improvement to adhesion between the two layers on the lithographic printing plate. The improved adhesion found with polymer MN-31 could be due to the many more free hydroxyl groups on polymer MN-31 (compared to polymer MN-24) that are available for crosslinking with the free hydroxyl groups of the bottom hydrophilic layer.

The imaged areas on the lithographic printing plate were almost completely clean after imaging, so the dry cleaning step that followed removed only trace amounts of debris. If no dry cleaning was carried out after imaging, the trace amounts of debris left on the printing plate after imaging were easily removed by the fountain solution on press. Indeed, fully imaged areas that were not dry cleaned, printed white background. Therefore, with this system it is possible to achieve literally processless lithographic printing plates using ablation for imaging.

### Invention Example 5

Lithographic printing plate precursors were prepared by using the following hydrophilic inner layer formulation prepared using the following components:

| Hydrophilic Inner Layer | | |
|---|---|---|
| Formulation | Weight (g) | Dry Weight % |
| Celvol ® 125 * PVA | 49.707 | 94.5 |
| Glyoxal solution** | 0.2924 | 5.5 |

* 4 weight % of PVA in water
**40 weight % of Glyoxal in water

This hydrophilic inner layer formulation was applied to an electrochemically roughened and anodized aluminum substrate that had been subjected to post-treatment using an aqueous solution of sodium phosphate/sodium fluoride by means of common methods and the formulation was dried for 4 minutes at 140° C. in an oven to provide a dry crosslinked hydrophilic inner layer coverage of about 1.7 g/m². This dried layer was then overcoated with an oleophilic surface layer formulation that was prepared by milling for 3 days (with metal balls) the following components (of Part A) that were then diluted before coating with the solvent mixture of part B:

| Oleophilic Surface Layer Formulation | Weight (g) | Dry Weight % |
|---|---|---|
| Part A - Milled base | | |
| Polymer MN-24 | 4.053 | 65 |
| MEK | 8.709 | 0 |
| PM | 16.175 | 0 |
| Mogul ® L carbon black | 2.182 | 35 |
| Part B - Solvents added to Part A after | | |
| milling | | |
| MEK | 1.004 | 0 |
| PM | 1.864 | 0 |

The oleophilic surface layer formulation was applied and dried for 2 hours at 170° C. or 15 minutes at 200° C. in an oven to provide a dry coverage of about 1.5 g/m².

When the oleophilic surface layer was oven-dried for 4 minutes at 170° C., as described in Invention Examples 1-4, a lower adhesion between the two layers was observed. Therefore, in this example, the coated oleophilic surface layer was dried at a higher oven temperature or oven drying was used for a longer duration to provide improved adhesion between the two layers.

The resulting lithographic printing plate was exposed using a Kodak® Thermo Flex 400, 1 Watt imager in a range of energies of 1000 mJ/cm² to 2400 mJ/cm² and wet cleaned with water. The imaged precursor was then mounted onto a Ryobi 520HX press and 20,000 impressions were made showing good image quality. A white printed background obtained, corresponding to a fully imaged area on the lithographic printing plate. This result was observed from the beginning of the printing test already at 1600 mJ/cm² (and above). For a lithographic printing plate precursor dried at a high temperature of 200° C. for 15 minutes, starting from ˜10,000 impressions, very weak toning of the white background was observed. Signs of wear, of fine features in particular (5% dots at 200 lpi screen) were seen starting from about 15,000 impressions.

### Solvent Resistance of the Imageable Elements:

Polymers MN-24 and MN-31 can be dissolved in PM or in a PM:MEK mixture that is used in oleophilic surface layer formulations. However, coatings obtained using these polymers are not soluble with PM.

The resistance to press chemicals of the lithographic printing plate precursors prepared in Invention Examples 1-5 were evaluated using the following tests:

Solvent Resistance Tests:

Four solvent mixtures were used for these tests:

(1) Butyl Cellosolve (“BC”, 2-butoxyethanol) test, 80% in water

(2) UV Wash test (“Glycol Ether” blends)

(3) Diacetone Alcohol test (“DAA”, 80% in water)

(4) Heatset Fountain Solution E9069/3 test at two different concentrations, 100% and 8% in water. Heatset Fountain Solution E9069/3 is commercial product that comprises 2-(2-butoxyethoxy)ethanol, Bronopol, ethanediol, and propan-2,1-diol.

For each test, drops of the each solvent mixture was placed on a 25% screen (200 lpi) region of the imaged lithographic printing plate precursors that were wet cleaned with water, and then the drops were removed with a cloth. Each test was carried out at about 23° C. A measurement of less than 5% reduction in the dot size (in regions on the 25% screen where drops of the solvents were present, compared to areas that had no solvent contact) is considered acceptable. The dot size before and 20 minutes after the solvent contact was measured using a spectroplate. After the solvent drops were on the precursors for 20 minutes, each imaged precursors was then mounted onto a Ryobi 520HX printing press and 5000 impressions were made to see if the dots remained on the lithographic printing plates. A spectrodense was used to measure the dot area on the printed impressions that corresponded to the regions on the printing plate precursors that had contact with the solvent mixtures and also those regions that had no contact with the solvents. As noted above, a measurement of less than 5% reduction in the dot size (in regions on the printed impressions corresponding to the 25% screen) is considered acceptable.

Excellent solvent resistance was found for the lithographic printing plate precursors prepared in Invention Examples 1, 3, 4, and 5 for all solvent mixtures used in the evaluations. Excellent solvent resistance was found also for the lithographic printing plates prepared in Invention Example 2. However, for the Invention Example 2 lithographic printing plates, only a moderate solvent resistance was observed with the concentrated Heatset Fountain Solution E9069/3. These results show that the oleophilic surface layer formulations containing the poly(vinyl acetal) having the carboxy-substituted phthalimide acetal recurring units n shown in Scheme 1, as primary binder within the scope of this invention, provided lithographic printing plates having excellent solvent resistance to a broad range of press chemicals.

The carboxy-substituted phthalimide acetal random recurring units n shown in Scheme 1 were found to be very efficient in making the lithographic printing plates solvent resistant (even when used in a relatively small amount as in Pol-MN-31). This is likely due to the strong π-stacking interaction between the phthalimido groups in the poly(vinyl acetal) resins that is further enhanced by the carboxy substituents in the polymers.

The invention has been described in detail with particular reference to certain preferred embodiments thereof, but it will be understood that variations and modifications can be effected within the spirit and scope of the invention.

1. A method of preparing a lithographic printing plate ready for lithographic printing comprising:
exposing a positive-working lithographic printing plate precursor to ablating infrared radiation of an energy of at least 1 J/cm² to form an ablated image in a lithographic printing plate ready for lithographic printing, wherein the positive-working lithographic printing plate precursor comprises a hydrophilic aluminum substrate, and comprises on the substrate:
a crosslinked hydrophilic inner layer, and
an oleophilic surface layer that is chemically bonded to the crosslinked hydrophilic inner layer, the oleophilic surface layer comprising at least one non-crosslinked oleophilic polymer.

2. The method of claim 1 wherein the oleophilic surface layer is chemically bonded to the crosslinked hydrophilic inner layer through covalent bonds, intermolecular bonds, or both covalent and intermolecular bonds.

3. The method of claim 1 wherein the oleophilic surface layer has solvent resistance as determined using the Butyl Cellusolve test.

4. The method of claim 1 wherein the oleophilic surface layer has solvent resistance as determined using the UV Wash test.

5. The method of claim 1 wherein the oleophilic surface layer has solvent resistance as determined using the Diacetone Alcohol test.

6. The method of claim 1 wherein the oleophilic surface layer has solvent resistance as determined using the Heatset Fountain Solution test.

7. The method of claim 1 wherein the at least one non-crosslinked oleophilic polymer in the oleophilic surface layer is a poly(vinyl acetal) polymer.

8. The method of claim 1 wherein the at least one non-crosslinked oleophilic polymer in the oleophilic surface layer is a poly(vinyl acetal) polymer comprising at least 15 mol % recurring units, based on total recurring units, represented by the following Structure (Ia): 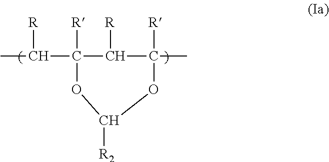
wherein R and R′ are independently hydrogen or a substituted or unsubstituted alkyl group, a substituted or unsubstituted cycloalkyl group, or halo group, and R₂ is an aryl group that is substituted with a cyclic imide group, which aryl or cyclic imide group can be further substituted.

9. The method of claim 8 wherein R₂ is a phenyl or naphthyl group that has a cyclic aliphatic or aromatic imide group selected from the group consisting of maleimide, phthalimide, tetrachlorophthalimide, hydroxyphthalimide, carboxypthalimide, nitrophthalimide, chlorophthalimide, bromophthalimide, and naphthalimide groups, wherein the phenyl, naphthyl, or cyclic aliphatic or aromatic imide group is optionally further substituted with one or more substituents selected from the group consisting of hydroxyl, alkyl, alkoxy, and halo groups.

10. The method of claim 8 wherein the at least one non-crosslinked oleophilic polymer in the oleophilic surface layer is a poly(vinyl acetal) polymer further comprising randomly occurring recurring units represented by any of the following Structures (Ib) through (Id): 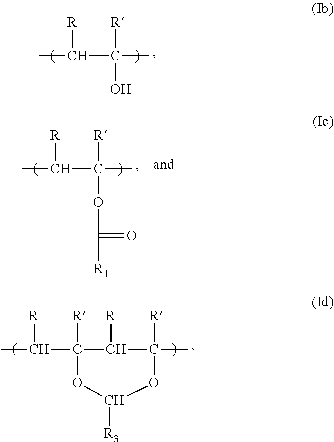
wherein R and R′ are independently hydrogen or a substituted or unsubstituted alkyl group, a substituted or unsubstituted cycloalkyl group, or a halo group,
R₁ is a substituted or unsubstituted linear or branched alkyl group having 1 to 12 carbon atoms, a substituted or unsubstituted cycloalkyl having 5 to 10 carbon atoms in the carbocyclic ring, or a substituted or unsubstituted aryl group having 6 or 10 carbon atoms in the aromatic ring, and
R₃ is an aryl group that is unsubstituted or substituted with at least one hydroxy group and optionally with a nitro group.

11. The method of claim 10 wherein R₃ is a nitro-substituted phenol, nitro-substituted naphthol, or nitro-substituted anthracenol.

12. The method of claim 1 wherein the oleophilic surface layer further comprises an infrared radiation absorbing compound.

13. The method of claim 1 wherein the oleophilic surface layer further comprises a carbon black infrared radiation absorbing compound.

14. The method of claim 1 wherein the oleophilic surface layer is chemically bonded to the crosslinked hydrophilic inner layer using a crosslinking agent that is selected from the group consisting of zirconium ammonium carbonate, ethane-1,2-dione, tetraethyl orthosilicate, tetramethyl orthosilicate, terephthalic aldehyde, and a melamine.

15. The method of claim 1 wherein the crosslinked hydrophilic inner layer comprises a crosslinked poly(vinyl alcohol).

16. The method of claim 1 wherein the crosslinked hydrophilic inner layer comprises a crosslinked poly(vinyl alcohol) obtained using zirconium ammonium carbonate, ethane-1,2-dione, tetramethyl orthosilicate, or tetraethyl orthosilicate as a crosslinking agent.

17. The method of claim 1 wherein the crosslinked hydrophilic inner layer comprises a crosslinked polymeric binder in an amount of at least 50 weight % and up to and including 100 weight % based on the total crosslinked hydrophilic inner layer dry weight.

18. The method of claim 1 wherein the crosslinked hydrophilic inner layer has a dry coverage of at least 0.5 and up to and including 4 g/m².

19. The method of claim 1 wherein the positive-working lithographic printing plate precursor further comprises an intermediate layer between and adhering the crosslinked hydrophilic inner layer and the oleophilic surface layer, the intermediate layer having a dry coverage of at least 0.1 and up to and including 0.5 g/m².

20. The method of claim 19 wherein the intermediate layer comprises a crosslinking agent and optionally an infrared radiation absorbing compound.

21. The method of claim 1 wherein the oleophilic surface layer has a dry coverage of at least 0.7 and up to and including 2.5 g/m².

22. The method of claim 1 further comprising:
without intermediate contact with a solution, using the lithographic printing plate having the ablated image for lithographic printing.

23. The method of claim 22 wherein the oleophilic surface layer further comprises an infrared radiation absorbing compound in a dry coverage of at least 2 and up to and including 45 weight %.

24. The method of claim 22 wherein the wherein the oleophilic surface layer is chemically bonded to the crosslinked hydrophilic inner layer through covalent bonds, intermolecular bonds, or both covalent and intermolecular bonds.

25. The method of claim 22 wherein imaging is carried out at an energy level of at least 1 and up to and including 4 J/cm².

26. The method of claim 22 wherein the lithographic printing plate having the ablated image is dry cleaned before being used for the lithographic printing.

27. The method of claim 22 comprising using the lithographic printing plate having the ablated image for lithographic printing without dry cleaning.

28. A method for preparing a lithographic printing plate precursor comprising:
to a hydrophilic aluminum substrate, applying an inner layer formulation comprising a hydrophilic polymer and a crosslinking agent for the hydrophilic polymer and drying to form a crosslinked hydrophilic inner layer,
applying an oleophilic surface layer formulation comprising at least one non-crosslinked oleophilic polymer to form an oleophilic surface layer on the hydrophilic inner layer,
drying the applied oleophilic surface layer to affect chemical bonding of the oleophilic surface layer to the crosslinked hydrophilic inner layer.

29. The method of claim 28 wherein the crosslinking agent is present in the inner layer formulation in an amount of at least 2% and up to and including 50% solids based on the inner layer formulation weight.

30. The method of claim 28 wherein the at least one non-crosslinked oleophilic polymer is a poly(vinyl acetal) polymer comprising recurring units that comprise an aryl group that is substituted with a cyclic imide group.

31. The method of claim 28 wherein the at least one non-crosslinked oleophilic polymer in the oleophilic surface layer formulation is a poly(vinyl acetal) polymer comprising at least 15 mol % of recurring units represented by the following Structure (Ia): 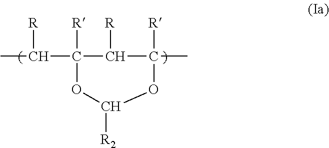
wherein R and R′ are independently hydrogen or a substituted or unsubstituted alkyl group, a substituted or unsubstituted cycloalkyl group, or halo group, and R₂ is an aryl group that is substituted with a cyclic imide group, which aryl or cyclic imide group can be further substituted.

32. The method of claim 28 wherein the crosslinking agent is selected from the group consisting of zirconium ammonium carbonate, ethane-1,2-dione, tetraethyl orthosilicate, tetramethyl orthosilicate, terephthalic aldehyde, and a melamine crosslinking agent.

33. The method of claim 28 wherein the inner layer formulation comprises a poly(vinyl alcohol) that is crosslinked during drying.

34. The method of claim 32 wherein the inner layer formulation comprises a poly(vinyl alcohol) that is crosslinked during the drying step using zirconium ammonium carbonate, ethane-1,2-dione, tetramethyl orthosilicate, or tetraethyl orthosilicate as a crosslinking agent.

35. The method of claim 28 further comprising applying an intermediate layer formulation to the dry hydrophilic inner layer between steps A and B, to provide upon drying, an intermediate layer having a dry coverage of at least 0.1 and up to and including 0.5 g/m².

36. The method of claim 35 wherein the intermediate layer formulation comprises a crosslinking agent and optionally an infrared radiation absorbing compound.

37. The method of claim 28 wherein the oleophilic surface layer formulation further comprises an infrared radiation absorbing compound in an amount to provide a dry coverage of at least 2 and up to and including 45 weight %.
